(19) United States
(12) Patent Application Publication
(10) Pub. No.: US 2015/0345944 A1
(43) Pub. Date: Dec. 3, 2015

(54) METHOD, APPARATUS, AND TERMINAL FOR MEASURING DIRECTION

(71) Applicant: Xiaomi Inc., Beijing (CN)

(72) Inventors: Yin ZHU, Beijing (CN); Wei HAN, Beijing (CN); Xiaowei HU, Beijing (CN)

(21) Appl. No.: 14/613,320

(22) Filed: Feb. 3, 2015

Related U.S. Application Data
(63) Continuation of application No. PCT/CN2014/089324, filed on Oct. 23, 2014.

(30) Foreign Application Priority Data
May 27, 2014 (CN) 201410227627.0

(51) Int. Cl. G01C 17/00; G01C 9/06; H04N 5/222

(52) U.S. Cl. CPC G01C 17/00; H04N 5/222; G01C 9/06; G01C 2009/066

(57) ABSTRACT

The present disclosure provides a method and an apparatus for measuring a direction, and a terminal. The method includes activating a camera and acquiring an image through the camera when the terminal runs a compass application (APP); determining a facing direction of the camera through the compass APP; and displaying, on a display interface, the facing direction in the image.

### RELATED APPLICATIONS

This application is a Continuation Application of International Application No. PCT/CN2014/089324, filed Oct. 23, 2014, which is based upon and claims priority to Chinese Patent Application No. CN201410227627.0, filed May 27, 2014, the entire contents of all of which are incorporated herein by reference.

### TECHNICAL FIELD

The present disclosure generally relates to the field of computer technology and, more particularly, to a method, an apparatus, and a terminal for measuring a direction.

### BACKGROUND

The development of terminal technology allows terminals to have more versatile functions. For example, a compass application (APP) may be installed on a terminal to measure a direction. If there is a need to measure a direction, the terminal may initiate the installed compass APP, and a virtual dial plate provided by the compass APP is displayed on the terminal, to display directions on the virtual dial plate.

### SUMMARY

According to a first aspect of embodiments of the present disclosure, there is provided a method for a terminal to measure a direction, the method including: activating a camera and acquiring an image through the camera when the terminal runs a compass application (APP); determining a facing direction of the camera through the compass APP; and displaying, on a display interface, the facing direction in the image.

According to a second aspect of embodiments of the present disclosure, there is provided a terminal, the terminal including: a processor; and a memory configured to store instructions executable by the processor; wherein the processor is configured to: activate a camera and acquire an image through the camera when the terminal runs a compass application (APP); determine a facing direction of the camera through the compass APP; and displaying, on a display interface, the facing direction in the image.

According to a third aspect of embodiments of the present disclosure, there is provided a non-transitory computer-readable storage medium having stored therein instructions that, when executed by a processor of a terminal, cause the terminal to perform a method for measuring a direction, the method including: activating a camera and acquiring an image through the camera when the terminal runs a compass application (APP); determining a facing direction of the camera through the compass APP; and displaying, on a display interface, the facing direction in the image.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1A is a flow chart showing a method for measuring a direction, according to an exemplary embodiment.

FIG. 1B shows schematic views of terminals, according to an exemplary embodiment.

FIG. 2A is a flow chart showing a method for measuring a direction, according to another exemplary embodiment.

FIG. 2B is a flow chart showing a method for detecting an inclined state of a terminal, according to another exemplary embodiment.

FIG. 2C is a flow chart showing a method for determining a facing direction of a camera, according to another exemplary embodiment.

FIG. 2D is a schematic view of a terminal, according to an exemplary embodiment.

FIG. 2E is a schematic view of a terminal, according to an exemplary embodiment.

FIG. 2F is a schematic view showing terminals displaying an application of a direction measurement, according to an exemplary embodiment.

FIG. 2G is a schematic view showing a terminal displaying a direction, according to an exemplary embodiment.

FIG. 2H is a flow chart showing a method for determining a deviation from a reference direction, according to another exemplary embodiment.

FIG. 2I is a schematic view showing a terminal displaying an application of detecting a direction, according to an exemplary embodiment.

FIG. 3 is a block diagram showing an apparatus for measuring a direction, according to an exemplary embodiment.

FIG. 4 is a block diagram showing an apparatus for measuring a direction, according to an exemplary embodiment.

FIG. 5 is a block diagram showing a device for measuring a direction, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the disclosure as recited in the appended claims.

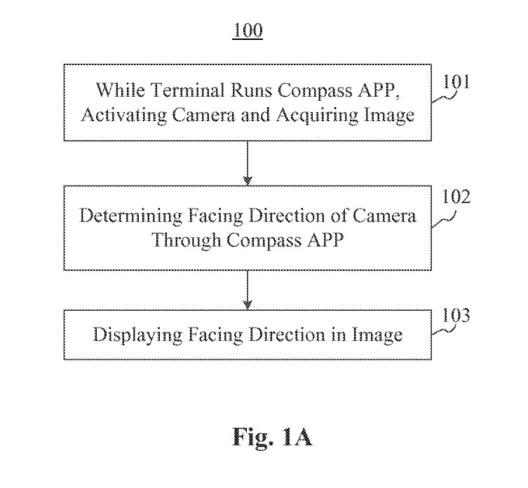

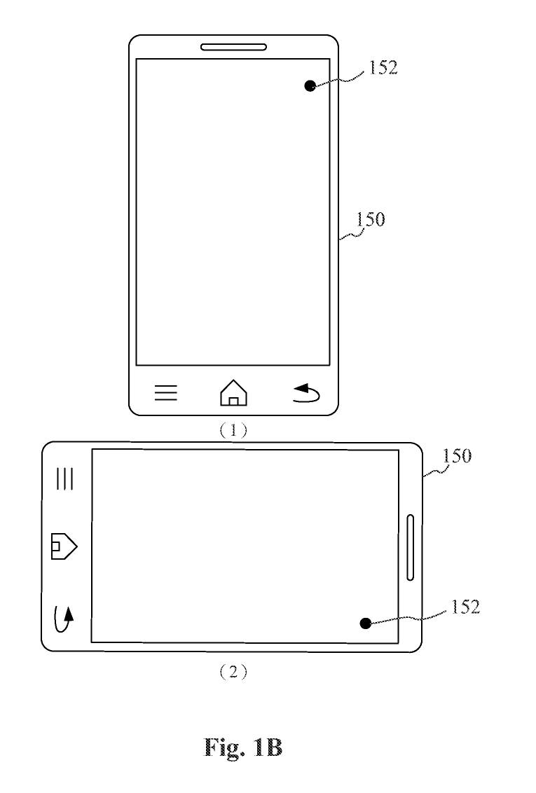

FIG. 1A is a flow chart showing a method 100 for measuring a direction, according to an exemplary embodiment. For example, the method 100 for measuring a direction may be performed by, but not limited to, a terminal including a camera and a compass APP. Referring to FIG. 1, the method 100 may include the following steps.

In step 101, while running the compass APP, the terminal activates the camera to acquire an image.

For example, when the terminal is running the compass APP, the terminal activates the camera. A current image is obtained through the camera and acquired by the terminal.

In step 102, a direction in which the camera is facing (facing direction) is determined through the compass APP.

Since the camera is mounted on the terminal and the compass APP may measure a direction of the terminal, the facing direction of the camera may be determined based on a direction of the terminal measured by the compass APP.

FIG. 1B is a schematic view showing a terminal 150 with a camera 152, according to an exemplary embodiment. The terminal 150 may be a portable device, such as a mobile phone, a tablet, etc. FIG. 1B(1) is a schematic view showing that the terminal 150 is held in a portrait orientation. FIG. 1B(2) is a schematic view showing that the terminal 150 is held in a landscape orientation. In FIG. 1B, the camera 152 is disposed at a back side of the terminal 150 and its facing direction is identical to the facing direction of the terminal 150, i.e., a direction being perpendicular to a front or back surface of terminal 150, pointing from a front side of the terminal to the back side of the terminal.

Referring back to FIG. 1A, in step 103, the facing direction is displayed in the acquired image of the real scene in front of the camera.

Since the scene is facing the camera, the facing direction of the camera measured by the compass APP can be used to mark the direction in the image. Thus, the direction in a real scene may be provided to the user through the terminal.

In the above embodiment, an exemplary method for measuring a direction is provided. While the terminal is running the compass APP, it may activate the camera to acquire an image. A facing direction of the camera may be determined by the compass APP and displayed in the image. Therefore, the facing direction of the camera may be directly displayed in the image, so that the terminal can provide a direction in an image of the real scene to the user, which effectively expands the terminal's function of measuring a direction.

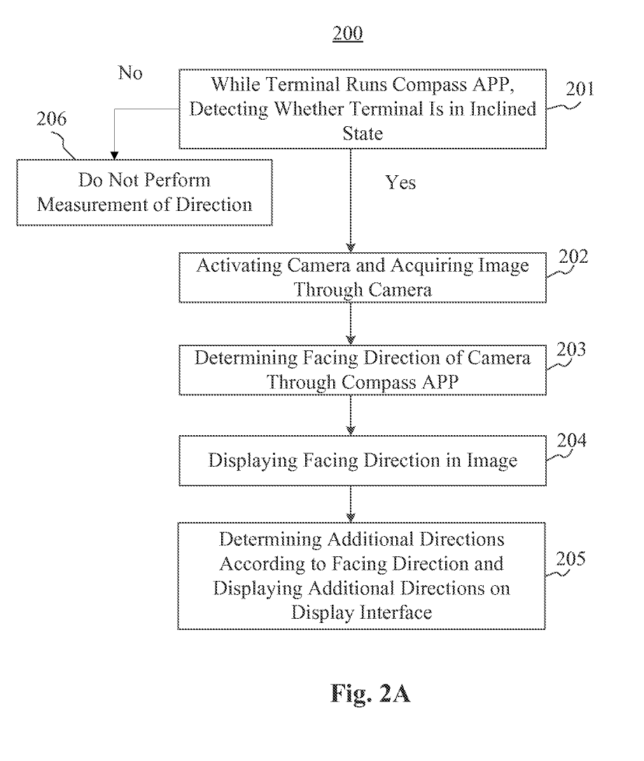

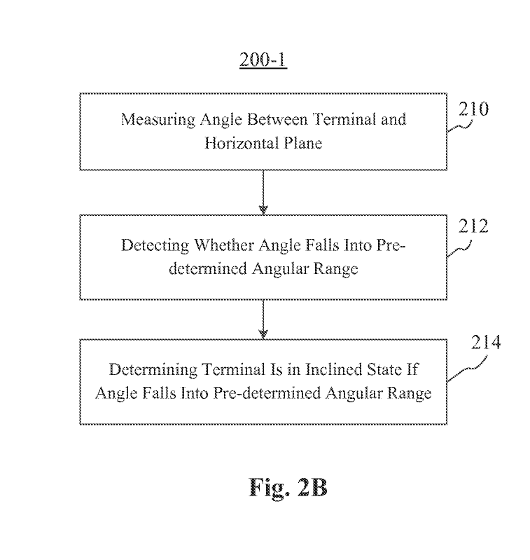

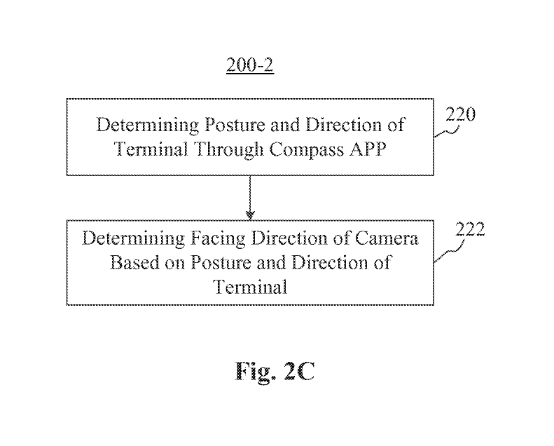

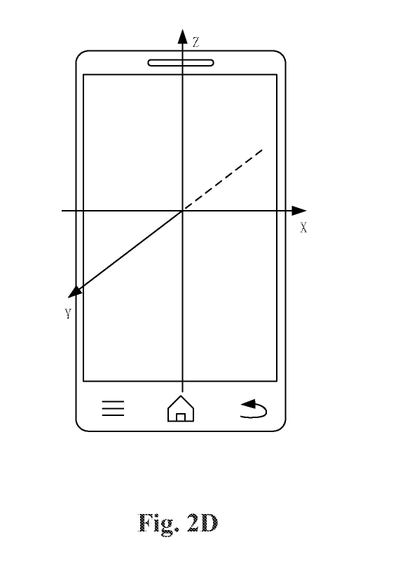

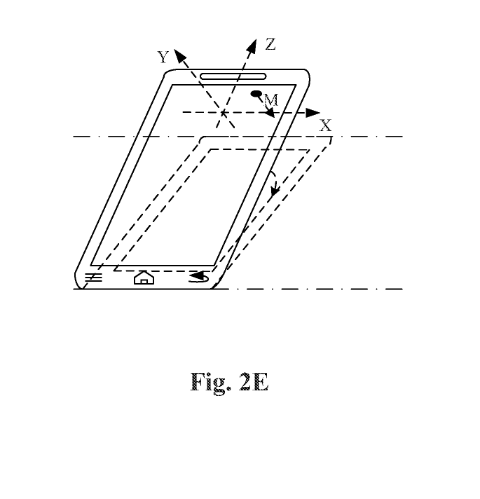

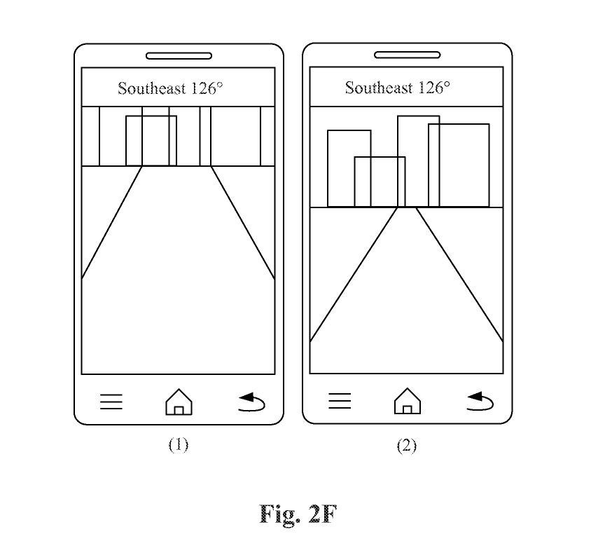

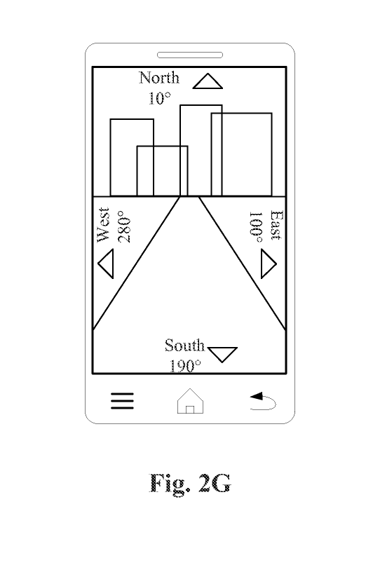

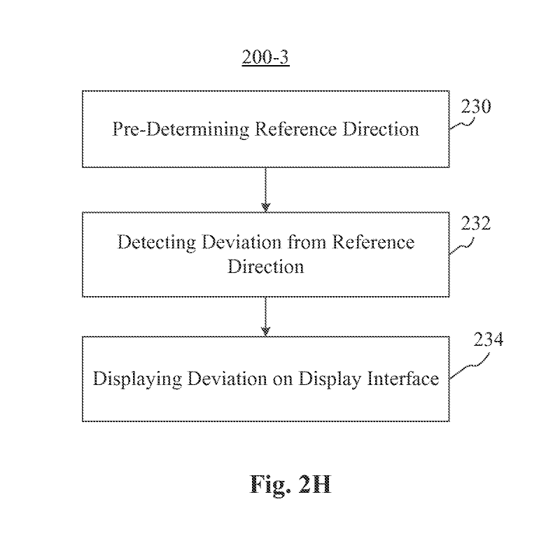

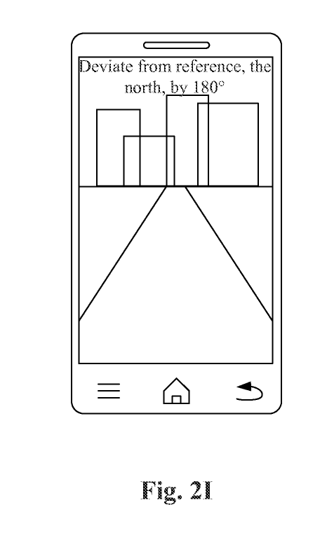

FIG. 2A is a flow chart showing a method 200 for measuring a direction, according to another exemplary embodiment. For example, the method 200 for measuring a direction may be performed by, but not limited to, a terminal including a camera and a compass APP. Referring to FIG. 2, the method 200 may include the following steps.

In step 201, while the terminal is running the compass APP, it detects whether it is inclined from a horizontal plane. If it detects that the terminal is in an inclined state, the process proceeds to step 202.

The method 200 for measuring direction is generally provided to measure a facing direction of the terminal. Therefore, if the terminal is not inclined from a horizontal plane, all the camera can pick up is an image of the ground, and the direction cannot be displayed on a real scene in front of the user holding the terminal. In order to avoid wasting resources to measure a direction, the terminal may first detect whether the terminal is in an inclined state from the horizontal plane. If the terminal is in an inclined state, the terminal may initiate the measurement of direction and activate the camera. If the terminal is in the horizontal plane, the process goes to step 206 in which the terminal does not perform measurement of the direction.

Referring to FIG. 2B, an exemplary method 200-1 for detecting whether the terminal is in the inclined state may include the following steps.

In step 210, an angle between the terminal and the horizontal plane is measured by a direction sensor of the terminal.

In step 212, the terminal detects whether the angle falls into a pre-determined angular range.

In step 214, if it is detected that the angle falls into the pre-determined angular range, it is determined that the terminal is in the inclined state.

To detect whether the terminal is in the inclined state, the terminal may activate the direction sensor included in the terminal to measure an inclination angle between the terminal and the horizontal plane. The inclination angle means the angle generated by rotating the terminal using a bottom side or a lateral side of the terminal as an axis, from the horizontal plane to a current position. An example is provided in FIG. 2E.

In some embodiments, the direction sensor may be a gyroscope sensor and/or an accelerometer sensor. The inclination angle of the terminal may be measured by the direction sensor according to, e.g., various known techniques.

After acquiring the inclination angle measured by the direction sensor, the terminal may also compare the inclination angle with the pre-determined angular range. If the inclination angle falls into the angular range, it is determined that the terminal is in the inclined state. If the inclination angle does not fall into the angle range, it is determined that the terminal is in the horizontal state. The angular range may be set, e.g., between 45° and 135°, between 5° and 175°, or between 30° and 150°, and so on.

In exemplary embodiments, if the inclination angle is greater than a predetermined value, the direction indicated by the terminal may be a direction opposite to the facing direction of the terminal. To provide accurate measurement, the predetermined value may be set as a maximum value of the angle range.

Referring back to FIG. 2A, when it is detected that the terminal is in the inclined state, the process goes to step 202. In step 202, the terminal activates the camera and acquires an image. When the camera is activated to be in an ON state, the camera images a scene in real time, which is displayed on a display interface.

In step 203, a facing direction of the camera is determined through the compass APP. Since the camera is mounted on the terminal and the compass APP may measure a direction of the terminal, the facing direction of the camera may be determined based on a measured direction of the terminal through the compass APP.

Referring to FIG. 2C, an exemplary method 200-2 for determining a facing direction of the camera through the compass APP may include the following steps.

In step 220, a posture of the terminal is determined, and a direction of the terminal is determined through the compass APP.

In step 222, the facing direction of the camera is determined based on the posture of the terminal and the direction of the terminal.

In some embodiments, a coordinate system of the terminal may be established in advance. Therefore, parameters with respect to each axis of the terminal while the terminal is in the current posture may be measured by a direction sensor. The measured parameters may be used to determine the posture of the terminal. As an example, a coordinate system of the terminal may be established when the terminal is disposed in a portrait orientation. The front surface of the terminal is set as an xz plane. A center point of the front surface is an origin point of the coordinate system; an axis pointing to the left of the terminal is an x axis in the positive direction; an axis perpendicular to the x axis on the front surface is a z axis; the z axis pointing to the top of the terminal is the z axis in the positive direction; an axis perpendicular to the display plane is a y axis; and an axis pointing to an upper side of the terminal from the xz plane is the y axis in the positive direction. A schematic view showing a coordinate system of a terminal 250 is shown in FIG. 2D.

In some embodiments, the parameters may be angles respectively rotating around the x, y, and z axes. Thus, a first parameter of the terminal rotating around the x axis, a second parameter rotating around the y axis, and a third parameter rotating around the z axis may be measured by the direction sensor, and the posture of the terminal may be determined based on the measured parameters. In other embodiments, the posture of the terminal may be measured by a gyroscope sensor, or by a combination of a gyroscope sensor and an accelerometer sensor, which are not limited in this disclosure.

In some embodiments, the compass APP may measure one or more directions for the terminal based on the posture of the terminal. In case where the camera is located on the back side of the terminal, the facing direction of the camera is the facing direction of the terminal. In case where the camera is located on the front side of the terminal, the facing direction of the camera is opposite to the facing direction of the terminal. The facing direction of the terminal refers to a direction pointing perpendicularly from the front side of the terminal to the back side of the terminal.

In case where the display surface of the terminal is perpendicular to the horizontal plane, the facing direction of the camera has been described above in connection with FIG. 1B. In case where the display surface of the terminal is not perpendicular to the horizontal plane, an exemplary schematic view of the facing direction of the camera is shown in FIG. 2E. In FIG. 2E, the coordinate system of the terminal is represented by an X axis, a Y axis and a Z axis, the facing direction of the camera is represented by an arrow M which is parallel with the Y axis and in an opposite direction of the Y axis.

In other embodiments, in order to inform the user of the rotating direction while the terminal is being rotated, the direction sensor may determine the facing direction of the camera at a predetermined time interval. For example, assuming that the terminal rotates counterclockwise from a horizontal plane around a bottom side, FIG. 2F shows an implementation of a direction measurement according to one embodiment. FIG. 2F(1) shows a display interface in case where the rotation angle is relatively small, and FIG. 2F(2) shows a display interface where the rotation angle is relatively large.

Referring back to FIG. 2A, in step 204, the facing direction is displayed in an image of a real scene in front of the camera.

Since the scene is facing the camera, the facing direction of the camera measured by the compass APP can be used to mark the direction in the image. Thus, the direction of the real scene may be provided to the user through the terminal.

The terminal may display in real time the measured facing direction of the camera in the image. The terminal may display the facing direction in the image in a form of a pointer or a numeral, for example, to improve the accuracy in marking the direction.

Referring to FIG. 2A again, in step 205, one or more additional directions are determined based on the facing direction. These additional directions include a direction opposite to the facing direction and a direction perpendicular to the facing direction et al. These additional directions are displayed on the display interface accordingly.

The terminal may calculate the direction opposite to the facing direction and the direction perpendicular to the facing direction based on the facing direction of the camera, and displays the calculated directions respectively at corresponding positions on the display interface.

FIG. 2G is a schematic view showing a terminal displaying directions according to one embodiment. If the compass APP measures that the facing direction of the camera is 10° from the north (0°), the terminal may display a legend “north 10°” on the upper side of the display interface. The terminal may display one or more additional directions as well. For example, an “east 100°” direction, which is perpendicular to “north 10°”, may be obtained by rotating the “north 10°” direction clockwise by 90 degrees and displayed on the right side of the display interface as shown in FIG. 2G. Moreover, a “south 190°” direction, which is opposite to “north 10°” may be obtained by rotating the “north 10°” direction clockwise for 180 degrees and displayed on the lower side of the display interface. Similarly, a “west 280°” direction, which is perpendicular to “north 10°”, may be obtained by rotating the “north 10°” direction clockwise by 270 degrees and displayed on the left side of the display interface.

In some embodiments, a deviation from a pre-determined reference direction may be displayed on a display interface. An exemplary method 200-3 of displaying the deviation is illustrated in FIG. 2H. The method 200-3 may include the following steps.

In step 230, a reference direction is pre-determined.

In step 232, an angle of the facing direction of the camera deviating from the reference direction is calculated.

In step 234, the deviation angle is displayed on the display interface.

In some embodiments, the reference direction may be set and modified. For example, the initial reference direction may be 0° from the north (“north 0°”) or “southeast 130°”, be modified to any other direction.

FIG. 2I is a schematic view showing a terminal according to one embodiment. The pre-determined reference direction is “north 0°” in the present embodiment. If the facing direction of the camera measured by the terminal is “south 180°”, the deviation angle is 180° from the north. The terminal shows a sentence, “Deviate from reference, the north, by 180°”, on the display interface along with an image, to indicate that the terminal is currently deviated from the reference direction.

According to the embodiments of the present disclosure, the terminal may run the compass APP and activate the camera to acquire an image. A facing direction of the camera may be determined by the compass APP and displayed in the image. Therefore, the facing direction of the camera may be directly displayed in the image, so that the terminal can provide a direction in an image having the real scene to the user, which effectively expands the terminal's function of measuring a direction.

In some embodiments, a deviation of the facing direction from a pre-determined reference direction may be determined and displayed on a display interface. A direction of an object in the image may be determined based on the pre-determined reference direction and the deviation, which may further expand the terminal's function of measuring a direction.

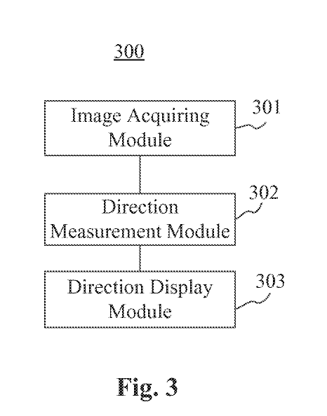

FIG. 3 is a block diagram showing an apparatus 300 for measuring a direction, according to an exemplary embodiment. For example, the apparatus 300 for measuring a direction may be implemented in, but not limited to, a terminal including a camera and a compass APP. Referring to FIG. 3, the apparatus 300 includes an image acquiring module 301, a direction measurement module 302, and a direction display module 303.

The image acquiring module 301 is configured to, while the terminal runs the compass APP, activate the camera and acquire an image through the camera.

The direction measurement module 302 is configured to determine a facing direction of the camera through the compass APP.

The direction display module 303 is configured to display the facing direction measured by the direction measurement module 302 in the image acquired by the image acquiring module 301.

Accordingly, the apparatus 300 for measuring a direction may be implemented in a terminal. While the terminal runs the compass APP, it may activate the camera to acquire an image. A facing direction of the camera is determined through the compass APP and displayed in the image. Therefore, the facing direction of the camera may be directly displayed in the objective image, so that the terminal can provide a direction in an image having the real scene to the user, which effectively expands the terminal's function of measuring a direction.

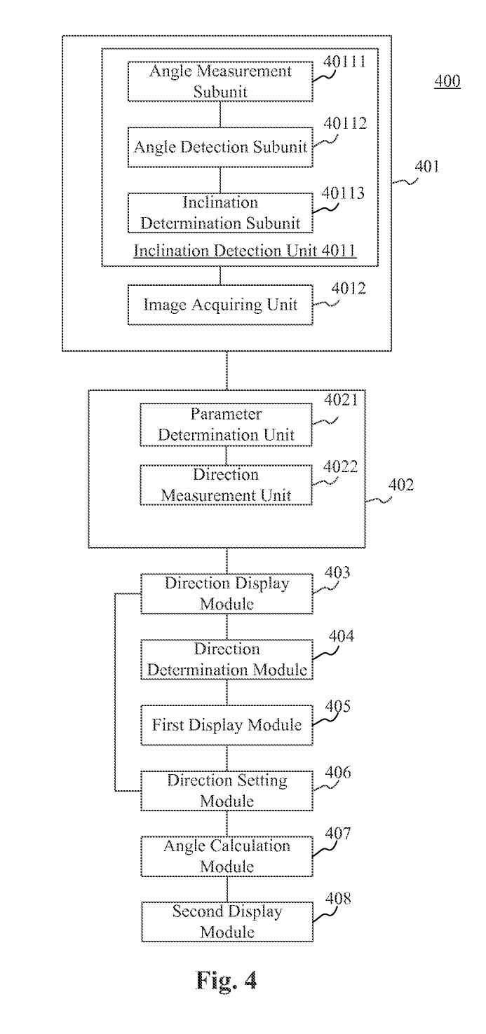

FIG. 4 is a block diagram showing an apparatus 400 for measuring a direction, according to an exemplary embodiment. For example, the apparatus 400 for measuring a direction may be implemented in, but not limited to, a terminal including a camera and a compass APP. Referring to FIG. 4, the apparatus 400 may include an image acquiring module 401, a direction measurement module 402, and a direction display module 403.

The image acquiring module 401 is configured to, while the terminal runs the compass APP, activate the camera and acquire an image through the camera.

The direction measurement module 402 is configured to determine a facing direction of the camera through the compass APP.

The direction display module 403 is configured to display the facing direction measured by the direction measurement module 402 in the image acquired by the image acquiring module 401.

In some embodiments, the image acquiring module 401 may include an inclination detection unit 4011 and an image acquiring unit 4012.

The inclination detection unit 4011 is configured to, while the terminal runs the compass APP, detect whether the terminal is in an inclined state.

The image acquiring unit 4012 is configured to, if the inclination detection unit 4011 detects that the terminal is in the inclined state, activate the camera and acquire an image through the camera.

In other embodiments, the inclination detection unit 4011 may include an angle measurement subunit 40111, an angle detection subunit 40112, and an inclination determination subunit 40113.

The angle measurement subunit 40111 is configured to measure an inclination angle between the terminal and a horizontal plane through a direction sensor of the terminal.

The angle detection subunit 40112 is configured to detect whether the inclination angle detected by the angle measurement subunit 40111 falls into a pre-determined angular range.

The inclination determination subunit 40113 is configured to, if the angle detection subunit 40112 detects that the inclination angle falls into the pre-determined angular range, determine that the terminal is in the inclined state.

In some embodiments, referring to FIG. 4, the direction measurement module 402 includes a parameter determination unit 4021 and a direction measurement unit 4022.

The parameter determination unit 4021 is configured to determine a posture of the terminal, and to determine a direction of the terminal through the compass APP.

The direction measurement unit 4022 is configured to determine the facing direction of the camera according to the posture of the terminal and a direction of the terminal determined by the parameter determination unit 4021.

In some embodiments, referring to FIG. 4, the apparatus 400 may further include a direction determination module 404 and a first display module 405.

The direction determination module 404 is configured to determine one or more additional directions of the terminal based on the facing direction. The additional directions may include, for example, a direction opposite to the facing direction and a direction perpendicular to the facing direction.

The first display module 305 is configured to display the additional directions correspondingly on the display interface.

In other embodiments, referring again to FIG. 4, the apparatus 400 may further include a direction setting module 406, an angle calculation module 407, and a second display module 408.

The direction setting module 406 is configured to pre-determine a reference direction.

The angle calculation module 407 is configured to calculate a deviation of the facing direction from the reference direction.

The second display module 408 is configured to display the deviation calculated by the angle calculation module 407 on the display interface.

Accordingly, the apparatus 400 for measuring a direction may be implemented in a terminal. While the terminal runs the compass APP, it may activate the camera to acquire an image. A facing direction of the camera is determined through the compass APP and displayed in the image. Therefore, the facing direction of the camera may be directly displayed in the image, so that the terminal can provide a direction in an image having the real scene to the user, which effectively expands the terminal's function of measuring a direction.

In some embodiments, a deviation of the facing direction from a pre-determined reference direction may be determined and displayed on a display interface. A direction of an object in the image may be determined based on the pre-determined reference direction and the deviation, which may further expand the terminal's function of measuring a direction.

In some embodiments, a terminal that performs the method for measuring a direction of the present disclosure may include a processor and a memory configured to store instructions executable by the processor. The processor is configured to execute the instructions to activate the camera and acquire an objective image through the camera while the terminal runs the compass APP. The terminal is further configured to determine a facing direction of the camera through the compass APP and display the facing direction in the image.

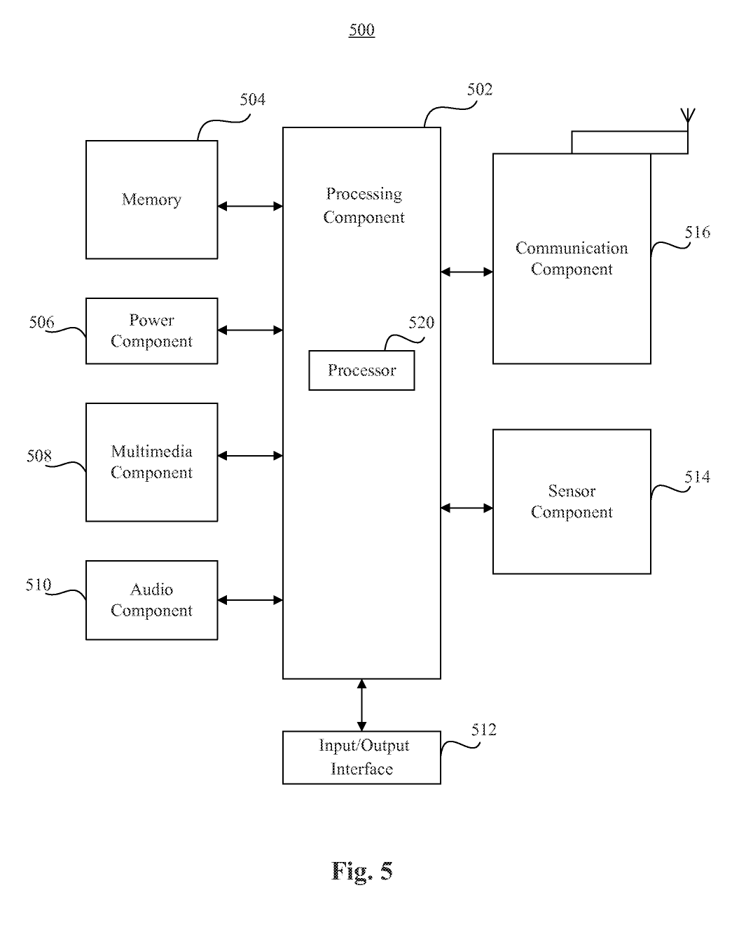

FIG. 5 is a block diagram showing a terminal 500 for measuring a direction, according to an exemplary embodiment. For example, the terminal 500 may be a mobile phone, a computer, a digital broadcast terminal, a messaging device, a gaming console, a tablet, a medical device, exercise equipment, a personal digital assistant, etc.

Referring to FIG. 5, the terminal 500 may include one or more of the following components: a processing component 502, a memory 504, a power component 506, a multimedia component 508, an audio component 510, an input/output (I/O) interface 512, a sensor component 514, and a communication component 516.

The processing component 502 typically controls overall operations of the terminal 500, such as the operations associated with display, telephone calls, data communications, camera operations, and recording operations. The processing component 502 may include one or more processors 518 to execute instructions to perform all or part of the steps in the above described methods. Moreover, the processing component 502 may include one or more modules which facilitate the interaction between the processing component 502 and other components. For instance, the processing component 502 may include a multimedia module to facilitate the interaction between the multimedia component 508 and the processing component 502.

The memory 504 is configured to store various types of data to support the operation of the terminal 500. Examples of such data include instructions for any applications or methods operated on the terminal 500, contact data, phonebook data, messages, pictures, video, etc. The memory 504 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 506 may include a power management system, one or more power sources, and any other components associated with the generation, management, and distribution of power in the terminal 500.

The multimedia component 508 includes a screen providing an output interface between the terminal 500 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 508 includes a front camera and/or a rear camera. The front camera and the rear camera may receive an external multimedia datum while the terminal 500 is in an operation mode, such as a photographing mode or a video mode. Each of the front camera and the rear camera may be a fixed optical lens system or have focus and optical zoom capability.

The audio component 510 is configured to output and/or input audio signals. For example, the audio component 510 includes a microphone configured to receive an external audio signal when the terminal 500 is in an operation mode, such as a call mode, a recording mode, and a voice recognition mode. The received audio signal may be further stored in the memory 504 or transmitted via the communication component 516. In some embodiments, the audio component 510 further includes a speaker to output audio signals.

The I/O interface 512 provides an interface between the processing component 502 and peripheral interface modules, such as a keyboard, a click wheel, buttons, and the like. The buttons may include, but are not limited to, a home button, a volume button, a starting button, and a locking button.

The sensor component 514 includes one or more sensors to provide status assessments of various aspects of the terminal 500. For instance, the sensor component 514 may detect an open/closed status of the terminal 500, relative positioning of components, e.g., the display and the keypad, of the terminal 500, a change in position of the terminal 500 or a component of the terminal 500, a presence or absence of user contact with the terminal 500, an orientation or an acceleration/deceleration of the terminal 500, and a change in temperature of the terminal 500. The sensor component 514 may include a proximity sensor configured to detect the presence of nearby objects without any physical contact. The sensor component 514 may also include a light sensor, such as a CMOS or CCD image sensor, for use in imaging applications. In some embodiments, the sensor component 514 may also include an accelerometer sensor, a gyroscope sensor, a magnetic sensor, a pressure sensor, or a temperature sensor.

The communication component 516 is configured to facilitate communication, wired or wirelessly, between the terminal 500 and other devices. The terminal 500 can access a wireless network based on a communication standard, such as WiFi, 2G, or 3G, or a combination thereof. In one exemplary embodiment, the communication component 516 receives a broadcast signal or broadcast associated information from an external broadcast management system via a broadcast channel. In one exemplary embodiment, the communication component 516 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the terminal 500 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 504, executable by the processor 518 in the terminal 500, for performing the above-described methods. For example, the non-transitory computer-readable storage medium may be a ROM, a RAM, a CD-ROM, a magnetic tape, a floppy disc, an optical data storage device, and the like.

One of ordinary skill in the art will understand that the above described modules/units can each be implemented by hardware, or software, or a combination of hardware and software. One of ordinary skill in the art will also understand that multiple ones of the above described modules/units may be combined as one module/unit, and each of the above described modules/units may be further divided into a plurality of sub-modules/sub-units.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for a terminal to measure a direction, comprising:
activating a camera and acquiring an image through the camera when the terminal runs a compass application (APP);
determining a facing direction of the camera through the compass APP; and
displaying, on a display interface, the facing direction in the image.

2. The method according to claim 1, wherein the activating of the camera and the acquiring of the image comprises:
detecting whether the terminal is in an inclined state when the terminal runs the compass APP; and
activating the camera to acquire the image through the camera if the terminal is in the inclined state.

3. The method according to claim 2, wherein the detecting of whether the terminal is in an inclined state comprises:
measuring an inclination angle between the terminal and a horizontal plane;
detecting whether the inclination angle falls into a pre-determined angular range; and
determining that the terminal is in the inclined state if the inclination angle falls into the pre-determined angular range.

4. The method according to claim 1, wherein the determining of the facing direction of the camera through the compass APP comprises:
determining a posture of the terminal;
determining a direction of the terminal through the compass APP; and
determining the facing direction of the camera based on the posture of the terminal and the direction of the terminal.

5. The method according to claim 4, further comprising:
determining additional directions based on the facing direction, the additional directions including a direction opposite to the facing direction and a direction perpendicular to the facing direction; and
displaying the additional directions on the display interface.

6. The method according to claim 1, further comprising:
pre-determining a reference direction;
calculating a deviation of the facing direction from the reference direction; and
displaying the deviation on the display interface.

7. A terminal, comprising:
a processor; and
a memory configured to store instructions executable by the processor;
wherein the processor is configured to:
activate a camera and acquire an image through the camera when the terminal runs a compass application (APP);
determine a facing direction of the camera through the compass APP; and
displaying, on a display interface, the facing direction in the image.

8. The terminal according to claim 7, wherein the processor is further configured to:
detect whether the terminal is in an inclined state when the terminal runs the compass APP; and
activate the camera to acquire the image through the camera if the terminal is in the inclined state.

9. The terminal according to claim 8, wherein the processor is further configured to:
measure an inclination angle between the terminal and a horizontal plane;
detect whether the inclination angle falls into a pre-determined angular range; and
determine that the terminal is in the inclined state if the inclination angle falls into the pre-determined angular range.

10. The terminal according to claim 7, wherein the processor is further configured to:
determine a posture of the terminal;
determine a direction of the terminal through the compass APP; and
determine the facing direction of the camera based on the posture of the terminal and the direction of the terminal.

11. The terminal according to claim 10, wherein the processor is further configured to:
determine additional directions based on the facing direction, the additional directions including a direction opposite to the facing direction and a direction perpendicular to the facing direction; and
display the additional directions on the display interface.

12. The terminal according to claim 7, wherein the processor is further configured to:
pre-determine a reference direction;
calculate a deviation of the facing direction from the reference direction; and
display the deviation on the display interface.

13. A non-transitory computer-readable storage medium having stored therein instructions that, when executed by a processor of a terminal, cause the terminal to perform a method for measuring a direction, the method comprising:
activating a camera and acquiring an image through the camera when the terminal runs a compass application (APP);
determining a facing direction of the camera through the compass APP; and
displaying, on a display interface, the facing direction in the image.

14. The non-transitory computer-readable storage medium according to claim 13, wherein the activating of the camera and the acquiring of the image comprises:
detecting whether the terminal is in an inclined state when the terminal runs the compass APP; and
activating the camera to acquire the image through the camera if the terminal is in the inclined state.

15. The non-transitory computer-readable storage medium according to claim 14, wherein the detecting of whether the terminal is in an inclined state comprises:
measuring an inclination angle between the terminal and a horizontal plane;
detecting whether the inclination angle falls into a pre-determined angular range; and
determining that the terminal is in the inclined state if it is detected that the inclination angle falls into the pre-determined angular range.

16. The non-transitory computer-readable storage medium according to claim 13, wherein the determining of the facing direction of the camera through the compass APP comprises:
determining a posture of the terminal;
determining a direction of the terminal through the compass APP; and
determining the facing direction of the camera based on the posture of the terminal and the direction of the terminal.

17. The non-transitory computer-readable storage medium according to claim 16, wherein the method further comprises:
determining additional directions based on the facing direction, the additional directions including a direction opposite to the facing direction and a direction perpendicular to the facing direction; and
displaying the additional directions on the display interface.

18. The non-transitory computer-readable storage medium according to claim 13, wherein the method further comprises:
pre-determining a reference direction;
calculating a deviation of the facing direction from the reference direction; and
displaying the deviation on the display interface.
